(19) United States
(12) Patent Application Publication
(10) Pub. No.: US 2023/0044985 A1
(43) Pub. Date: Feb. 9, 2023

(54) TRAVEL CONTROLLER, METHOD FOR TRAVEL CONTROL, AND NON-TRANSITORY COMPUTER-READABLE MEDIUM CONTAINING COMPUTER PROGRAM FOR TRAVEL CONTROL

(71) Applicant: TOYOTA JIDOSHA KABUSHIKI KAISHA, Toyota-shi (JP)

(72) Inventor: Eiki KITAGAWA, Tokyo-to (JP)

(21) Appl. No.: 17/805,574

(22) Filed: Jun. 6, 2022

(30) Foreign Application Priority Data
Aug. 4, 2021 (JP) 2021-128511

(51) Int. Cl. B60W 30/18; B60W 50/14

(52) U.S. Cl. CPC B60W 30/18163; B60W 50/14; B60W 2554/802; B60W 2720/106

(57) ABSTRACT

A travel controller requests a driver of a vehicle to perform a pre-lane-change action required of the driver to make a lane change from a first lane to a second lane adjoining the first lane, and changes the speed of the vehicle with a first acceleration until the driver performs the pre-lane-change action after the request and with a second acceleration having a greater absolute value than the first acceleration after the driver performs the pre-lane-change action, thereby controlling the speed of the vehicle to reduce the distance to a lane change position defined to make the lane change. The lane change position depends on the positional relationship between the vehicle and a moving object on the second lane.

### FIELD

The present disclosure relates to a controller, a method, and a computer program for controlling travel of a vehicle.

### BACKGROUND

A known travel controller causes a vehicle to make a lane change from a first lane to a second lane, using information representing the situation around the vehicle and outputted by a sensor, such as a camera, mounted on the vehicle. Such a travel controller causes a vehicle to make a lane change to move to a lane toward a route leading to a destination or to a passing lane for passing a slowly-moving leading vehicle.

Japanese Unexamined Patent Publication No. 2019-217825 (hereafter, “Patent Literature 1”) describes a travel controller that controls acceleration/deceleration and steering of a vehicle, based on the situation around the vehicle. The travel controller described in Patent Literature 1 determines the area in which a candidate for a target position for a lane change is searched for or set, depending on the type of the lane change.

### SUMMARY

Making a lane change planned by a travel controller may be conditional on a driver's predetermined action, such as holding a steering wheel. When planning such a lane change, a travel controller suggests a lane change to a driver and requests him/her to perform a predetermined action. If the driver does not perform the predetermined action after the suggestion of a lane change, such a lane change will not be made even when a host vehicle moves to a position where the lane change can be made. The motion of the host vehicle at this time may give an unnatural impression to a driver of another vehicle. The vehicle driver who has an unnatural impression may change the motion of his/her vehicle, which may change the situation that the host vehicle can make a lane change to a situation that it is impossible.

It is an object of the present disclosure to provide a travel controller that enables an appropriate lane change.

The travel controller according to the present disclosure includes a processor configured to request a driver of a vehicle to perform a pre-lane-change action required of the driver to make a lane change from a first lane to a second lane adjoining the first lane, and to change the speed of the vehicle with a first acceleration until the driver performs the pre-lane-change action after the request and with a second acceleration having a greater absolute value than the first acceleration after the driver performs the pre-lane-change action, thereby controlling the speed of the vehicle to reduce the distance to a lane change position defined to make the lane change. The lane change position depends on the positional relationship between the vehicle and a moving object on the second lane.

In the case that the driver has not performed the pre-lane-change action and that a predicted time required to move from the current position of the vehicle to the lane change position is longer than a time threshold, the processor of the travel controller according to the present disclosure preferably changes the speed of the vehicle with a third acceleration whose absolute value is greater than the absolute value of the first acceleration and less than the absolute value of the second acceleration, thereby executing control so that the vehicle approaches the lane change position.

The processor of travel controller according to the present disclosure preferably further configured to steer the vehicle so that the vehicle moves from the first lane to the second lane, in the case that the driver has performed the pre-lane-change action and that the vehicle has reached the lane change position.

A method for travel control according to the present disclosure includes requesting a driver of a vehicle to perform a pre-lane-change action required of the driver to make a lane change from a first lane to a second lane adjoining the first lane; and changing the speed of the vehicle with a first acceleration until the driver performs the pre-lane-change action after the request and with a second acceleration having a greater absolute value than the first acceleration after the driver performs the pre-lane-change action, thereby controlling the speed of the vehicle to reduce the distance to a lane change position defined to make the lane change. The lane change position depends on the positional relationship between the vehicle and a moving object on the second lane.

A computer program for travel control stored in a non-transitory computer-readable medium according to the present disclosure causes a computer mounted on a vehicle to execute a process including requesting a driver of the vehicle to perform a pre-lane-change action required of the driver to make a lane change from a first lane to a second lane adjoining the first lane; and changing the speed of the vehicle with a first acceleration until the driver performs the pre-lane-change action after the request and with a second acceleration having a greater absolute value than the first acceleration after the driver performs the pre-lane-change action, thereby controlling the speed of the vehicle to reduce the distance to a lane change position defined to make the lane change. The lane change position depends on the positional relationship between the vehicle and a moving object on the second lane.

The travel controller according to the present disclosure enables an appropriate lane change.

### BRIEF DESCRIPTION OF DRAWINGS

FIG. 1 schematically illustrates the configuration of a vehicle equipped with a travel controller.

FIG. 2 schematically illustrates the hardware of an ECU.

FIG. 3 is a functional block diagram of a processor included in the ECU.

FIGS. 4A, 4B, and 4C are diagrams for explaining first, second, and third states of a first example of travel control, respectively.

FIGS. 5A, 5B, and 5C are diagrams for explaining first, second, and third states of a second example of travel control, respectively.

FIG. 6 is a flowchart of a travel control process.

### DESCRIPTION OF EMBODIMENTS

A travel controller that enables an appropriate lane change will now be described in detail with reference to the attached drawings. Before making a lane change from a first lane to a second lane adjoining the first lane, the travel controller requests a driver of a vehicle to perform a pre-lane-change action required of the driver to make a lane change. The travel controller changes the speed of the vehicle with a first acceleration until the driver performs the pre-lane-change action after the request, thereby controlling the speed of the vehicle to reduce the distance to a lane change position. The lane change position is defined to make the lane change and depends on the positional relationship between the vehicle and a moving object on the second lane. After the driver performs the pre-lane-change action, the travel controller changes the speed of the vehicle with a second acceleration, thereby executing control so that the vehicle approaches the lane change position. The second acceleration has a greater absolute value than the first acceleration.

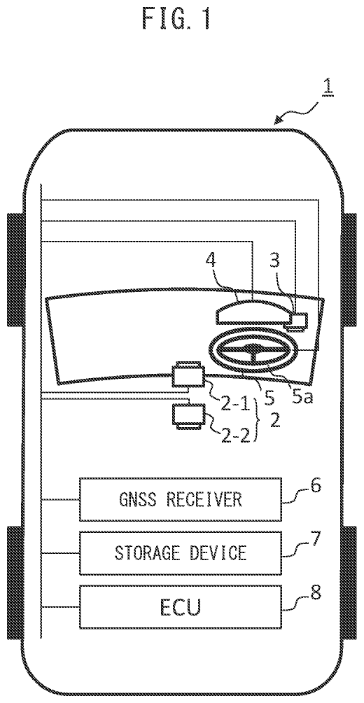

FIG. 1 schematically illustrates the configuration of a vehicle equipped with the travel controller.

The vehicle 1 includes a surround capturing camera 2, a driver monitoring camera 3, a meter display 4, a steering wheel 5, a global navigation satellite system (GNSS) receiver 6, a storage device 7, and an electronic control unit (ECU) 8, which is an example of the travel controller. The surround capturing camera 2, the driver monitoring camera 3, the meter display 4, the steering wheel 5, the GNSS receiver 6, and the storage device 7 are connected to the ECU 8 via an in-vehicle network conforming to a standard, such as a controller area network, so that they can communicate with each other.

The surround capturing camera 2 is an example of a surround capturing sensor for generating situation data depending on the situation around the vehicle 1. The surround capturing camera 2 includes a two-dimensional detector constructed from an array of optoelectronic transducers, such as CCD or C-MOS, having sensitivity to visible light and a focusing optical system that forms an image of a target region on the two-dimensional detector. The surround capturing camera 2 includes a front camera 2-1 and a rear camera 2-2. For example, the front camera 2-1 is disposed in a front and upper area in the interior of the vehicle and oriented forward whereas the rear camera 2-2 is disposed in a rear and upper area in the interior of the vehicle and oriented rearward. The surround capturing camera 2 takes pictures of the surroundings of the vehicle 1 through front and rear windshields every predetermined capturing period (e.g., 1/30 to 1/10 seconds), and outputs images of the surroundings as the situation data.

The driver monitoring camera 3 is an example of a driver capturing unit for generating a face image representing a face region of the vehicle driver. The driver monitoring camera 3 includes a two-dimensional detector constructed from an array of optoelectronic transducers, such as CCD or C-MOS, having sensitivity to infrared light, a focusing optical system that forms an image of a target region on the two-dimensional detector, and a light source that emits infrared light. The driver monitoring camera 3 is mounted, for example, in a front area in the interior of the vehicle and oriented toward the face of the driver sitting on the driver's seat. The driver monitoring camera 3 irradiates the driver with infrared light every predetermined capturing period (e.g., 1/30 to 1/10 seconds), and sequentially outputs images representing the driver's face.

The meter display 4, which is an example of an output device, includes, for example, a liquid crystal display. The meter display 4 displays information on a pre-lane-change action required of the driver to make a lane change so as to be visible to the driver, according to a signal received from the ECU 8 via the in-vehicle network.

The steering wheel 5 is an example of an operation unit, and is operated by the driver who makes a steering mechanism that steers the vehicle 1 operate. The operation to make the steering mechanism operate is, for example, turning the steering wheel 5 clockwise or counterclockwise. The steering wheel 5 includes a touch sensor 5a that detects hold of the steering wheel 5 by the driver. The touch sensor 5a outputs a signal depending on the presence or absence of hold of the steering wheel 5 by the driver.

The GNSS receiver 6 receives GNSS signals from GNSS satellites at predetermined intervals, and determines the position of the vehicle 1, based on the received GNSS signals. The GNSS receiver 6 outputs a positioning signal indicating the result of determination of the position of the vehicle 1 based on the GNSS signals to the ECU 8 via the in-vehicle network at predetermined intervals.

The storage device 7, which is an example of a storage unit, includes, for example, a hard disk drive or a nonvolatile semiconductor memory. The storage device 7 contains map data including information on features, such as lane-dividing lines, in association with their positions.

The ECU 8 plans a lane change, based on the positions and speeds of traveling vehicles around the vehicle 1 represented in an image of the surroundings generated by the surround capturing camera 2. The ECU 8 requests the driver of the vehicle 1 to perform a pre-lane-change action required for making the planned lane change, and makes a lane change on condition that the driver performs the pre-lane-change action.

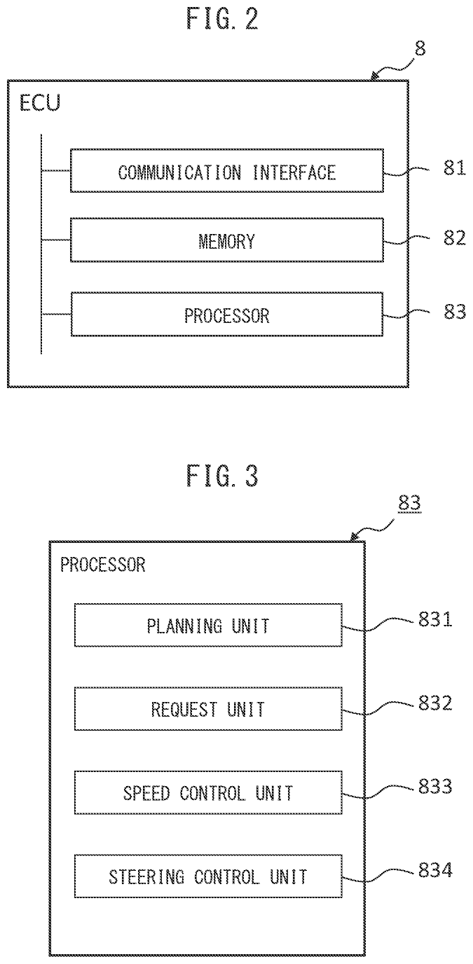

FIG. 2 schematically illustrates the hardware of the ECU 8. The ECU 8 includes a communication interface 81, a memory 82, and a processor 83.

The communication interface 81, which is an example of a communication unit, includes a communication interface circuit for connecting the ECU 8 to the in-vehicle network. The communication interface 81 provides received data for the processor 83, and outputs data provided from the processor 83 to an external device.

The memory 82 includes volatile and nonvolatile semiconductor memories. The memory 82 contains various types of data used for processing by the processor 83, e.g., an action request image displayed as a request for a pre-lane-change action; an action request voice played back as a request for a pre-lane-change action; a criterion for determining whether the pre-lane-change action has been performed; and first and second accelerations for changing the speed of the vehicle, depending on whether the driver has performed the pre-lane-change action. The memory 82 also contains various application programs, such as a travel control program to execute a travel control process.

The processor 83, which is an example of a control unit, includes one or more processors and a peripheral circuit thereof. The processor 83 may further include another operating circuit, such as a logic-arithmetic unit, an arithmetic unit, or a graphics processing unit.

FIG. 3 is a functional block diagram of the processor 83 included in the ECU 8.

As its functional blocks, the processor 83 of the ECU 8 includes a planning unit 831, a request unit 832, a speed control unit 833, and a steering control unit 834. These units included in the processor 83 are functional modules implemented by a computer program stored in the memory 82 and executed by the processor 83. The computer program for achieving the functions of the processor 83 may be provided in a form recorded on a computer-readable and portable medium, such as a semiconductor memory, a magnetic medium, or an optical medium. Alternatively, the units included in the processor 83 may be implemented in the ECU 8 as separate integrated circuits, microprocessors, or firmware.

The planning unit 831 plans a lane change, based on the position and speed of a vehicle traveling on a lane adjacent to the travel lane of the vehicle 1 and represented in an image of the surroundings generated by the surround capturing camera 2. The vehicle on the adjacent lane is an example of a moving object.

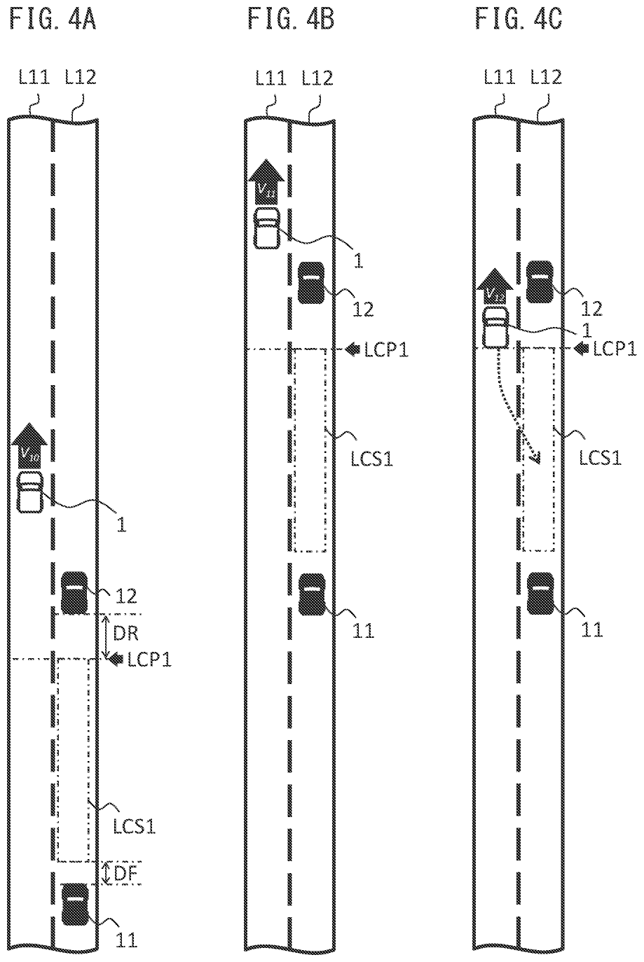

FIGS. 4A, 4B, and 4C are diagrams for explaining first, second, and third states of a first example of travel control, respectively.

FIG. 4A represents a first state of the first example of travel control in which the vehicle 1 is traveling on a lane L11 at a speed V₁₀. The planning unit 831 inputs an image of the surroundings outputted by the rear camera 2-2 into a classifier that has been trained to detect vehicles and lane-dividing lines, thereby detecting vehicles 11 and 12 traveling on a lane L12 adjoining the lane L11 behind the vehicle 1.

The classifier may be, for example, a convolutional neural network (CNN) including convolution layers connected in series from the input toward the output. A CNN that has been trained in accordance with a predetermined training technique, such as backpropagation, using images including vehicles and lane-dividing lines as training data operates as a classifier to determine the positions of vehicles and lane-dividing lines.

The planning unit 831 tracks objects detected as vehicles from each of images of the surroundings outputted at different times, and identifies the regions corresponding to the vehicles 11 and 12 in the images. The planning unit 831 then estimates the distances to the vehicles, using, for example, the heights of the vehicles in one of the images outputted at a predetermined time, the height of a standard vehicle, and the focal length of the optical system of the surround capturing camera 2 that has outputted the image. The planning unit 831 also estimates the positions of the vehicles 11 and 12, using the estimated distances to the vehicles, the imaging direction of the surround capturing camera 2, and the position of the host vehicle identified with a positioning signal obtained from the GNSS receiver 6.

The planning unit 831 estimates the speed for each of the vehicles 11 and 12, using the distance between the positions of the vehicle at different times and the interval between these times. In the first example of travel control, the vehicles 11 and 12 are traveling at the same speed greater than the speed V₁₀.

When the distance between the vehicles 11 and 12 is greater than a predetermined cut-in threshold, the planning unit 831 sets a lane change space LCS1 between the vehicles 11 and 12, depending on the positional relationship between the vehicle 1 and the vehicles 11 and 12. The lane change space LCS1 is a space between the vehicles 11 and 12 from a position a forward distance DF away from the front edge of the vehicle 11 traveling behind to a position a rearward distance DR away from the rear edge of the vehicle 12 traveling ahead.

In the case that the vehicles 11 and 12 are traveling on the lane L12 at different speeds, the length of the lane change space LCS1 varies with the passage of time. For example, in the case that the vehicle 11 traveling behind is faster than the vehicle 12 traveling ahead, the length of the lane change space LCS1 decreases with the passage of time. When it is predicted that the length of the lane change space LCS1 after a predetermined period will be less than the cut-in threshold, the planning unit 831 does not set the lane change space LCS1 between the vehicles 11 and 12.

When three or more vehicles traveling faster than the speed V₁₀ are detected on the lane L12 behind the vehicle 1, the planning unit 831 detects the distances between the detected vehicles. In this case, the planning unit 831 sets the lane change space LCS1 in the interval closest to the vehicle 1, of the intervals whose lengths at the time of detection and after a predetermined period are greater than the cut-in threshold.

When a single vehicle traveling faster than the speed V₁₀ is detected on the lane L12 behind the vehicle 1, the planning unit 831 sets the lane change space LCS1 ahead of or behind the detected vehicle, depending on the difference between the speeds of the vehicle 1 and the detected vehicle and the distance to the detected vehicle. For example, when the speeds of the vehicle 1 and the detected vehicle greatly differ and the distance to the detected vehicle is short, the planning unit 831 sets the lane change space LCS1 behind the detected vehicle.

The planning unit 831 sets a lane change position LCP1 at the position in the lane change space LCS1 closest to the vehicle 1, and plans a lane change at the lane change position LCP1. Since the vehicles 11 and 12 are traveling faster than the speed V₁₀, the lane change position LCP1 viewed from the vehicle 1 moves forward from behind during travel of the vehicle 1.

The request unit 832 requests the driver of the vehicle 1 to perform a pre-lane-change action required of the driver of the vehicle to make a lane change from a first lane to a second lane adjoining the first lane. The pre-lane-change action is to hold the steering wheel 5. Alternatively, the pre-lane-change action may be to turn the face in the direction of the destination lane or to perform a predetermined button operation.

For example, the request unit 832 causes an action request image stored in the memory 82 to appear on the meter display 4, thereby requesting the driver of the vehicle 1 to perform the pre-lane-change action. The action request image includes a text such as “Please hold the steering wheel” or an image representing the state in which the steering wheel is held. The vehicle 1 may include a speaker (not shown) as an output device; the request unit 832 may play back an action request voice stored in the memory 82 with the speaker, thereby requesting the driver of the vehicle 1 to perform the pre-lane-change action.

The speed control unit 833 determines whether the driver has performed the pre-lane-change action after the request.

When hold of the steering wheel 5 is detected on the basis of a signal received from the touch sensor 5a of the steering wheel 5, the speed control unit 833 determines that the driver has performed the pre-lane-change action.

When the pre-lane-change action is to turn the face in the direction of the destination lane, the speed control unit 833 detects the driver's looking direction, based on a face image outputted by the driver monitoring camera 3. The speed control unit 833 detects pupils and corneal reflection images of the light source as characteristic points by template matching of the face image with templates representing pupils and corneal reflection images of a light source, and calculates the looking direction, based on their positional relationship. When the detected looking direction is within a predetermined range of directions from the position of the host vehicle toward the destination lane L12, the speed control unit 833 determines that the driver has performed the pre-lane-change action.

When the pre-lane-change action is to perform a predetermined button operation, the speed control unit 833 determines whether the driver has performed the pre-lane-change action, depending on whether a signal corresponding to the operation is received via the in-vehicle network.

The speed control unit 833 changes the speed of the vehicle 1 with a first acceleration until the driver performs the pre-lane-change action, thereby executing control to reduce the distance from the vehicle 1 to the lane change position LCP1. Additionally, the speed control unit 833 changes the speed of the vehicle 1 with a second acceleration having a greater absolute value than the first acceleration after the driver performs the pre-lane-change action, thereby executing control to reduce the distance from the vehicle 1 to the lane change position LCP1.

FIG. 4B represents a second state of the first example of travel control in which the driver has not performed the requested pre-lane-change action and the vehicle 1 is traveling on the lane L11. The speed control unit 833 decelerates the vehicle 1 from the speed V₁₀ to a speed V₁₁ with the first acceleration until the driver performs the pre-lane-change action. In this example, the first acceleration is −0.1 G, and the speed V₁₁ is less than the speed V₁₀. More specifically, since the speed V₁₁ of the vehicle 1 after the change is less than that of the vehicles 11 and 12, the lane change position LCP1 viewed from the vehicle 1 moves forward relative to its position in the first state illustrated in FIG. 4A.

FIG. 4C represents a third state of the first example of travel control in which the driver has performed the requested pre-lane-change action and the vehicle 1 is traveling on the lane L11. The speed control unit 833 decelerates the vehicle 1 from the speed V₁₀ to a speed V₁₂ with the second acceleration after the driver performs the pre-lane-change action. In this example, the second acceleration is −0.5 G, and has a greater absolute value than the first acceleration. Since the speed V₁₂ is less than the speed V₁₁, the lane change position LCP1 viewed from the vehicle 1 moves further forward relative to its position in the second state illustrated in FIG. 4B.

The steering control unit 834 steers the vehicle 1 so that it moves from the first lane to the second lane, in the case that the driver has performed the pre-lane-change action and that the vehicle 1 has reached the lane change position LCP1.

In the third state of the first example of travel control illustrated in FIG. 4C, the driver has performed the pre-lane-change action. The steering control unit 834 determines whether the vehicle 1 has reached the lane change position LCP1 set depending on the positions of the vehicles 11 and 12 detected from an image of the surroundings outputted by the rear camera 2-2. When it is determined that the vehicle 1 has reached the lane change position LCP1, the steering control unit 834 transmits, via the in-vehicle network to the steering mechanism that steers the vehicle 1, a steering signal for operating the steering mechanism so that the vehicle 1 moves from the first lane to the second lane.

The steering control unit 834 may transmit the steering signal on condition that the vehicle 1 has reached the lane change position LCP1 and that the situation around the vehicle 1 satisfies a surrounding condition. The surrounding condition is based on, for example, topographic features (e.g., the road section is neither sharp curve nor steep slope). The steering control unit 834 can obtain the topographic features around the position of the vehicle 1, which is obtained by the GNSS receiver 6, from map information stored in the storage device 7. The topographic features may be detected from an image of the surroundings generated by the surround capturing camera 2.

In the first state of the first example of travel control illustrated in FIGS. 4A to 4C, it is assumed that each of the vehicles 1, 11, and 12 travels at a constant speed. In this case, a predicted required time necessary for moving from the current position of the vehicle 1 to the lane change position LCP1 can be calculated by dividing the distance from the current position of the vehicle 1 to the lane change position LCP1 by the difference between the speed V₁₀ of the vehicle 1 and that of the vehicles 11 and 12.

The required time increases as the difference between the speed V₁₀ of the vehicle 1 and that of the vehicles 11 and 12 decreases. When the required time calculated on the basis of the speed V₁₀ of the vehicle 1 and that of the vehicles 11 and 12 is longer than a predetermined time threshold, the speed control unit 833 may decelerate the vehicle 1 with a third acceleration, thereby executing control to reduce the distance between the vehicle 1 and the lane change position LCP1. The absolute value of the third acceleration is greater than that of the first acceleration and less than that of the second acceleration. The third acceleration is preferably set at an acceleration such that the brake lights are not turned on, e.g., −0.35 G.

The first, second, and third accelerations preferably have the same sign. Alternatively, the first acceleration may be zero, and in this case, the second and third accelerations preferably have the same sign.

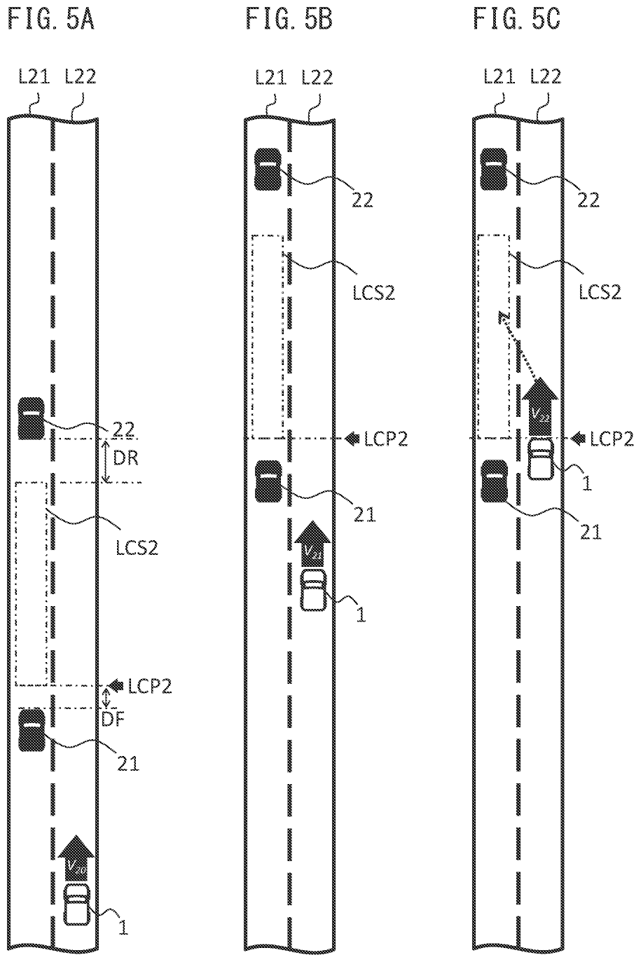

FIGS. 5A, 5B, and 5C are diagrams for explaining first, second, and third states of a second example of travel control, respectively.

FIG. 5A represents a first state of the second example of travel control in which the vehicle 1 is traveling on a lane L22 at a speed V₂₀. The planning unit 831 inputs an image of the surroundings outputted by the front camera 2-1 into a classifier that has been trained to detect vehicles and lane-dividing lines, thereby detecting vehicles 21 and 22 traveling on a lane L21 adjoining the lane L22 ahead of the vehicle 1. The vehicles 21 and 22 are traveling at speeds less than the speed V₂₀.

When the distance between the vehicles 21 and 22 is greater than the predetermined cut-in threshold, the planning unit 831 sets a lane change space LCS2 between the vehicles 21 and 22, depending on the positional relationship between the vehicle 1 and the vehicles 21 and 22. The lane change space LCS2 is a space between the vehicles 21 and 22 from a position a forward distance DF away from the front edge of the vehicle 21 traveling behind to a position a rearward distance DR away from the rear edge of the vehicle 22 traveling ahead. The planning unit 831 sets a lane change position LCP2 at the position in the lane change space LCS2 closest to the vehicle 1, and plans a lane change at the lane change position LCP2. Since the vehicles 21 and 22 are traveling slower than the speed V₂₀, the lane change position LCP2 viewed from the vehicle 1 moves relatively backward from the front during travel of the vehicle 1.

The request unit 832 requests the driver of the vehicle 1 to perform a pre-lane-change action required of the driver of the vehicle to make a lane change from a first lane to a second lane adjoining the first lane.

The speed control unit 833 determines whether the driver has performed the pre-lane-change action after the request.

The speed control unit 833 changes the speed of the vehicle 1 with a first acceleration until the driver performs the pre-lane-change action, thereby executing control to reduce the distance from the vehicle 1 to the lane change position LCP2. Additionally, the speed control unit 833 changes the speed of the vehicle 1 with a second acceleration having a greater absolute value than the first acceleration after the driver performs the pre-lane-change action, thereby executing control to reduce the distance from the vehicle 1 to the lane change position LCP2.

FIG. 5B represents a second state of the second example of travel control in which the driver has not performed the requested pre-lane-change action and the vehicle 1 is traveling on the lane L22. The speed control unit 833 changes the speed of the vehicle 1 from the speed V₂₀ to a speed V₂₁ with the first acceleration until the driver performs the pre-lane-change action. In this example, the first acceleration is 0 G, and the speed V₂₁ is equal to the speed V₂₀. More specifically, since the speed V₂₁ of the vehicle 1 after the change is greater than the speeds of the vehicles 21 and 22, the lane change position LCP2 viewed from the vehicle 1 moves backward relative to its position in the first state illustrated in FIG. 5A.

FIG. 5C represents a third state of the second example of travel control in which the driver has performed the requested pre-lane-change action and the vehicle 1 is traveling on the lane L22. The speed control unit 833 accelerates the vehicle 1 from the speed V₂₀ to a speed V₂₂ with the second acceleration after the driver performs the pre-lane-change action. In this example, the second acceleration is 0.5 G, and has a greater absolute value than the first acceleration. Since the speed V₂₂ is greater than the speed V₂₁, the lane change position LCP2 viewed from the vehicle 1 moves further backward relative to its position in the second state illustrated in FIG. 5B.

The steering control unit 834 steers the vehicle 1 so that it moves from the first lane L22 to the second lane L21, in the case that the driver has performed the pre-lane-change action and that the vehicle 1 has reached the lane change position LCP2.

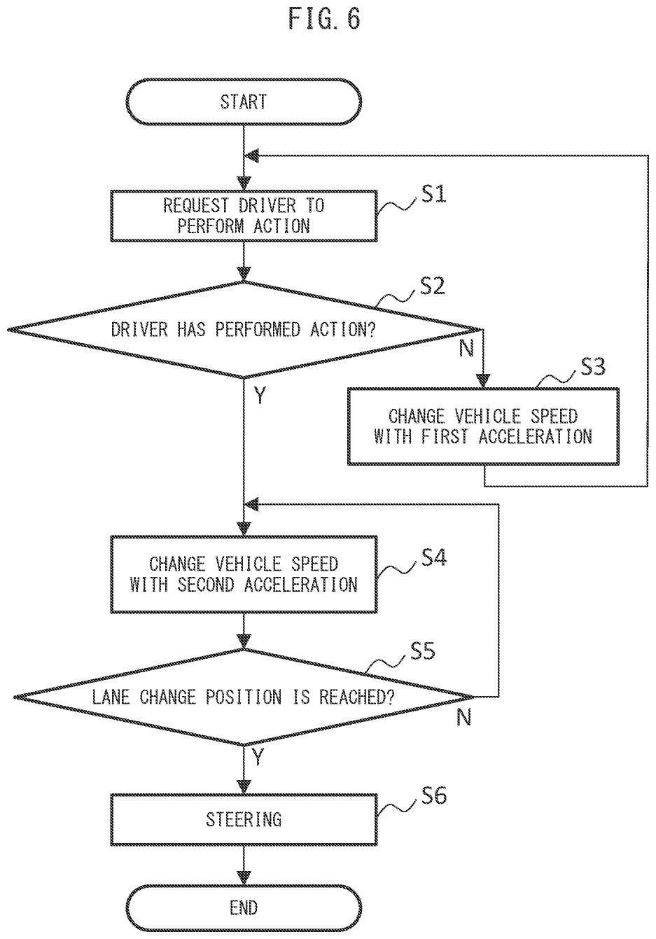

FIG. 6 is a flowchart of a travel control process. Whenever the planning unit 831 plans a lane change, the ECU 8 executes the travel control process.

First, the request unit 832 of the processor 83 of the ECU 8 requests the driver of the vehicle to perform a pre-lane-change action required of the driver to make a lane change from a first lane to a second lane adjoining the first lane (step S1).

The speed control unit 833 of the processor 83 of the ECU 8 determines whether the driver has performed the pre-lane-change action after the request (step S2).

When it is determined that the driver has not performed the pre-lane-change action (No in step S2), the speed control unit 833 changes the speed of the vehicle 1 with a first acceleration, thereby controlling the speed of the vehicle 1 to reduce the distance to a lane change position defined to make the lane change (step S3). The lane change position depends on the positional relationship between the vehicle and a moving object on the second lane. The process by the processor 83 of the ECU 8 then returns to step S1, and the request unit 832 continues requesting the driver to perform a pre-lane-change action.

When it is determined that the driver has performed the pre-lane-change action (Yes in step S2), the speed control unit 833 changes the speed of the vehicle 1 with a second acceleration having a greater absolute value than the first acceleration, thereby controlling the speed of the vehicle 1 to reduce the distance to the lane change position (step S4).

Next, the steering control unit 834 of the processor 83 of the ECU 8 determines whether the vehicle 1 has reached the lane change position (step S5).

When it is determined that the vehicle 1 has not reached the lane change position (No in step S5), the process by the processor 83 of the ECU 8 returns to step S4, and control continues so that the vehicle 1 approaches the lane change position.

When it is determined that the vehicle 1 has reached the lane change position (Yes in step S5), the steering control unit 834 of the processor 83 of the ECU 8 steers the vehicle 1 so that it moves from the first lane to the second lane (step S6) and terminates the travel control process.

Such a travel control process enables the ECU 8 to make a lane change appropriately.

The vehicle 1 may include a light detection and ranging (LiDAR) sensor or a radio detection and ranging (RADAR) sensor as a surround capturing sensor. The LIDAR sensor or the RADAR sensor outputs a range image whose pixels each have a value depending on the distance to an object represented in the pixel, based on the situation around the vehicle 1, as the situation data.

Note that those skilled in the art can apply various changes, substitutions, and modifications without departing from the spirit and scope of the present disclosure.

What is claimed is:

1. A travel controller comprising a processor configured to:
request a driver of a vehicle to perform a pre-lane-change action required of the driver to make a lane change from a first lane to a second lane adjoining the first lane; and
change the speed of the vehicle with a first acceleration until the driver performs the pre-lane-change action after the request and with a second acceleration having a greater absolute value than the first acceleration after the driver performs the pre-lane-change action, thereby controlling the speed of the vehicle to reduce the distance to a lane change position defined to make the lane change, the lane change position depending on the positional relationship between the vehicle and a moving object on the second lane.

2. The travel controller according to claim 1, wherein in the case that the driver has not performed the pre-lane-change action and that a predicted time required to move from the current position of the vehicle to the lane change position is longer than a time threshold, the processor changes the speed of the vehicle with a third acceleration whose absolute value is greater than the absolute value of the first acceleration and less than the absolute value of the second acceleration, thereby executing control to reduce the distance to the lane change position.

3. The travel controller according to claim 1, wherein the processor is further configured to steer the vehicle so that the vehicle moves from the first lane to the second lane, in the case that the driver has performed the pre-lane-change action and that the vehicle has reached the lane change position.

4. A method for travel control, comprising:
requesting a driver of a vehicle to perform a pre-lane-change action required of the driver to make a lane change from a first lane to a second lane adjoining the first lane; and
changing the speed of the vehicle with a first acceleration until the driver performs the pre-lane-change action after the request and with a second acceleration having a greater absolute value than the first acceleration after the driver performs the pre-lane-change action, thereby controlling the speed of the vehicle to reduce the distance to a lane change position defined to make the lane change, the lane change position depending on the positional relationship between the vehicle and a moving object on the second lane.

5. A non-transitory computer-readable medium containing a computer program for travel control, the computer program causing a computer mounted on a vehicle to execute a process comprising:
requesting a driver of the vehicle to perform a pre-lane-change action required of the driver to make a lane change from a first lane to a second lane adjoining the first lane; and
changing the speed of the vehicle with a first acceleration until the driver performs the pre-lane-change action after the request and with a second acceleration having a greater absolute value than the first acceleration after the driver performs the pre-lane-change action, thereby controlling the speed of the vehicle to reduce the distance to a lane change position defined to make the lane change, the lane change position depending on the positional relationship between the vehicle and a moving object on the second lane.
